(19) United States
(12) Patent Application Publication
(10) Pub. No.: US 2020/0033968 A1
(43) Pub. Date: Jan. 30, 2020

(54) TOUCH PANEL DISPLAY INCLUDING ANTENNA

(71) Applicant: Sharp Kabushiki Kaisha, Sakai City, Osaka (JP)

(72) Inventors: Shinji YAMAGISHI, Sakai City (JP); Yasuhiro SUGITA, Sakai City (JP); Jean MUGIRANEZA, Sakai City (JP)

(21) Appl. No.: 16/336,928

(22) PCT Filed: Sep. 27, 2017
(86) PCT No.: PCT/JP2017/034899

§ 371 Date: Mar. 27, 2019

(30) Foreign Application Priority Data
Sep. 29, 2016 (JP) 2016-191405

(51) Int. Cl. G06F 3/044

(52) U.S. Cl. CPC G06F 3/044

(57) ABSTRACT

The invention achieves reduction in thickness and suppression of erroneous operation of a touch panel caused by noise of an antenna in the touch panel including the antenna configured to read information by means of near field wireless communication. A touch panel display including an antenna includes the antenna configured to read information by means of near field wireless communication. The touch panel display including the antenna includes a first substrate 2 and a second substrate 1, a display medium layer 3 interposed between these substrates, and a first touch sensor electrode 24T provided on a surface, adjacent to the display medium layer 3, of the first substrate 2. The first substrate 2 is provided with a second touch sensor electrode 24R and an antenna 25 that are disposed in an identical layer on a surface opposite to the surface adjacent to the display medium layer 3.

### TECHNICAL FIELD

The present invention relates to a touch panel display, and particularly relates to a touch panel display including an antenna for near field wireless communication.

### BACKGROUND ART

In recent years, there has often been adopted a technique for near field communication between an IC card (contactless IC card) not including any power supply but including a wireless communication antenna element, and a communication device including a power supply, without contact therebetween. In an exemplary case where the communication device and the contactless IC card make wireless communication (near field communication), the contactless IC card is brought close to the communication device so as to be distant by at most a predetermined distance from an antenna element of the communication device. When the communication device including the power supply supplies electric power to the incorporated antenna element for near field wireless communication, the antenna element generates a magnetic field. The magnetic field generated by the communication device causes induced current to flow to the antenna element of the contactless IC card that is brought close to the communication device. This achieves supply of electric power from the communication device to the contactless IC card. The contactless IC card causes a circuit (e.g. an IC chip) provided in the contactless IC card to operate by means of electromotive force generated by the induced current. This enables wireless communication (near field communication) between the communication device and the contactless IC card that is brought close to the communication device.

US 2009/0231299 A discloses a device including a touch panel display equipped with such an antenna element. The device according to US 2009/0231299 A includes a liquid crystal display terminal, a touch panel, and an antenna layer, which are layered together.

### SUMMARY

The touch panel and the antenna layer provided in different layers as in Patent Literature 1 inevitably lead to increase in thickness of the entire device. The touch panel and the antenna layer being layered are likely to have erroneous operation of the touch panel due to noise from the antenna.

In view of the above problems, it is an object of the following disclosure to achieve reduction in thickness of a touch panel display including an antenna and suppression of erroneous operation of a touch panel caused by noise of the antenna.

In order to achieve the object mentioned above, a touch panel display including an antenna configured to read information using near field wireless communication is provided. The touch panel display includes a first substrate and a second substrate; a display medium interposed between the first substrate and the second substrate; and a first touch sensor electrode provided on a display medium side of the first substrate. The first substrate includes a second touch sensor electrode and the antenna that are disposed in an identical layer on a surface of the first substrate opposite to the display medium.

The above configuration achieves provision of a touch panel display including an antenna having reduced thickness and suppressing erroneous operation of a touch panel caused by noise of the antenna.

### BRIEF DESCRIPTION OF DRAWINGS

FIG. 1 is a sectional view depicting a schematic configuration of a touch panel display according to an embodiment.

FIG. 2 is a pattern diagram depicting relation between drive electrodes and sensing electrodes of a touch panel.

FIG. 3 is a plan view depicting a schematic configuration of the drive electrodes provided on a color filter substrate.

FIG. 4 is a sectional view depicting a configuration of a common transition electrode for connection of the drive electrode on the color filter substrate to a TFT substrate.

FIG. 5 is a plan pattern diagram depicting configurations of the sensing electrodes provided on the color filter substrate and an antenna pattern.

### DESCRIPTION OF EMBODIMENT

The following description relates to an embodiment of the invention.

A touch panel display including an antenna according to a first configuration includes the antenna configured to read information by means of near field wireless communication. This touch panel display including the antenna includes a first substrate and a second substrate, a display medium interposed between the first substrate and the second substrate, and a first touch sensor electrode provided on a surface, adjacent to the display medium, of the first substrate. The first substrate is provided with a second touch sensor electrode and the antenna that are disposed in an identical layer on a surface opposite to the surface adjacent to the display medium.

The first substrate has one of surfaces provided thereon with the second touch sensor electrode configured to detect a touch and disposed in a layer including the antenna, to achieve reduction in thickness of the display in comparison to a conventional configuration including a touch panel and an antenna disposed in layers different from each other. The antenna pattern disposed in a layer including a sensing electrode reduces influence of antenna noise in comparison to a case where the sensing electrode and the antenna pattern are layered.

A touch panel display including an antenna according to a second configuration includes the first or second configuration in which the display medium is liquid crystal, the second substrate is a circuit board provided with a driver element, and the first substrate is a color filter substrate.

The second touch sensor electrode and the antenna provided adjacent to the first substrate (the color filter substrate) in this manner reduce influence of noise from the second substrate provided with the driver element, on the second touch sensor electrode and the antenna.

A touch panel display including an antenna according to a third configuration includes the second configuration in which the first touch sensor electrode is a drive electrode and the second touch sensor electrode is a sensing electrode.

Out of the drive electrode and the sensing electrode provided for detection of a touch, the drive electrode is disposed on the color filter substrate to be adjacent to the liquid crystal layer, and the sensing electrode is disposed opposite thereto (far from the circuit board provided with the driver element). This disposition reduces influence of noise from the circuit board configured to receive a drive signal for image display, on a detection signal read out of the sensing electrode. This enables detection of a touch at appropriate timing without limitation by drive timing for image display.

A touch panel display including an antenna according to a fourth configuration includes any one of the first to third configurations in which the second touch sensor electrode and the antenna are disposed in parallel with each other in an image display region of the touch panel display on the surface of the first substrate opposite to the display medium.

This configuration includes the second touch sensor electrode and the antenna being aligned regularly, so that the second touch sensor electrode and the antenna are unlikely to be visually recognized.

A touch panel display including an antenna according to a fifth configuration includes the fourth configuration in which the antenna has a loop shape or a spiral shape having two or more spirals, and the antenna has a portion that is not in parallel with the second touch sensor electrode and is disposed outside the image display region.

The portion of the antenna not in parallel with the second touch sensor electrode is at least partially disposed outside the image display region in this configuration. Even when the antenna has the loop shape or the spiral shape having two or more spirals, this deposition suppresses visual recognition of the portion of the antenna not in parallel with the second touch sensor electrode.

A touch panel display including an antenna according to a sixth configuration includes the fifth configuration and further includes a flexible circuit board, in which the antenna has a portion that is not in parallel with the second touch sensor electrode and is at least partially disposed on the flexible circuit board.

The portion of the antenna not in parallel with the second touch sensor electrode is at least partially disposed on the flexible circuit board in this configuration. Even when the antenna has the loop shape or the spiral shape having two or more spirals, this deposition suppresses visual recognition of the portion of the antenna not in parallel with the second touch sensor electrode.

### Embodiment

An embodiment of the present invention will be described in detail below with reference to the drawings. Identical or corresponding portions in the drawings will be denoted by identical reference signs and will not be described repeatedly. For clearer description, the drawings to be referred to hereinafter may depict simplified or schematic configurations or may not depict some of constructional elements. The constructional elements in each of the drawings may not necessarily be depicted in actual dimensional ratios.

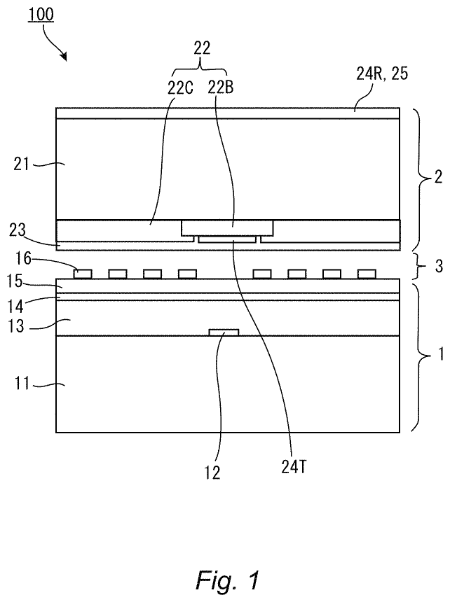

FIG. 1 is a sectional view depicting a schematic configuration of a touch panel display including an antenna (hereinafter, simply referred to as the touch panel display) 100 according to an embodiment of the present invention. The present embodiment exemplifies a case where the touch panel display 100 is configured as a liquid crystal display. FIG. 1 and the remaining drawings do not depict known elements such as a backlight unit, which will not be described in detail herein.

The touch panel display 100 includes a TFT substrate 1 and a color filter substrate 2. The TFT substrate 1 and the color filter substrate 2 interpose a liquid crystal layer 3 enclosed therebetween. The TFT substrate 1 is provided with a TFT (not depicted) functioning as a driver element, a line used for supply of a signal to the TFT, and the like.

As depicted in FIG. 1, the TFT substrate 1 includes a light-transmissive substrate 11 provided thereon with lines such as a gate line 12. The gate line 12 is connected to the TFT not appearing in the section depicted in FIG. 1, and supplies the TFT with a gate drive signal. The TFT is connected also to a source line not appearing in the section depicted in FIG. 1. The gate line 12, the remaining lines, and the TFT are covered with an insulating film 13. The insulating film 13 may include different types of layered films. The insulating film 13 is provided thereon with a transparent auxiliary electrode 14. The transparent auxiliary electrode 14 is provided thereon with an insulating film 15. The insulating film 15 is provided thereon with a pixel electrode 16. The pixel electrode 16 is provided thereon with an oriented film (not depicted).

The present embodiment exemplifies a case where the color filter substrate 2 is also provided with a pixel electrode 16, although the liquid crystal display, to which the present invention is applicable, is not limited to such a configuration. The present invention is also applicable to a display according to the so-called IPS system, the FFS system, or the like, in which the color filter substrate 2 is provided with no pixel electrode and the TFT substrate 1 is provided with a comb electrode.

The color filter substrate 2 includes a color filter layer 22 disposed on a surface adjacent to the liquid crystal layer 3, of a light-transmissive substrate 21. The color filter layer 22 includes color filters 22C of respective colors R, G, and B or the like, and a black matrix 22B. The black matrix 22B covers portions, provided with the lines and the TFT, of the TFT substrate 1. FIG. 1 exemplarily depicts the section in which the black matrix 22B covers the portion provided with the gate line 12. The color filter layer 22 has a surface adjacent to the liquid crystal layer 3 and provided with an ITO film 23 functioning as a counter electrode. The ITO film 23 has a surface provided with the oriented film (not depicted).

In the touch panel display 100 according to the present embodiment, the color filter substrate 2 is provided with a drive electrode and a sensing electrode configured to detect a touched position. FIG. 1 exemplarily depicts the color filter substrate 2 provided, on the surface adjacent to the liquid crystal layer 3, with a plurality of drive electrodes 24T. The plurality of drive electrodes 24T is disposed in parallel with each other. Each of the drive electrodes 24T is disposed between the black matrix 22B and the ITO film 23 to be overlapped with the black matrix 22B.

The color filter substrate 2 has a surface to receive touch operation (touch surface) provided with a plurality of sensing electrodes 24R. The plurality of sensing electrodes 24R is disposed in parallel with each other. The sensing electrodes 24R and the drive electrodes 24T extend perpendicularly to each other. The sensing electrodes 24R are disposed in a layer including an antenna pattern 25.

The sensing electrodes 24R and the antenna pattern 25 may alternatively be disposed directly on the glass substrate 21 of the color filter substrate 2. Still alternatively, there may be provided an adhesive layer, a protective layer, or any appropriate optical layer such as a refractive index protective film or a light diffusion film, which is interposed between the glass substrate 21 and the sensing electrodes 24R as well as the antenna pattern 25. The sensing electrodes 24R and the antenna pattern 25 may alternatively be provided on surfaces thereof with a glass cover or the like.

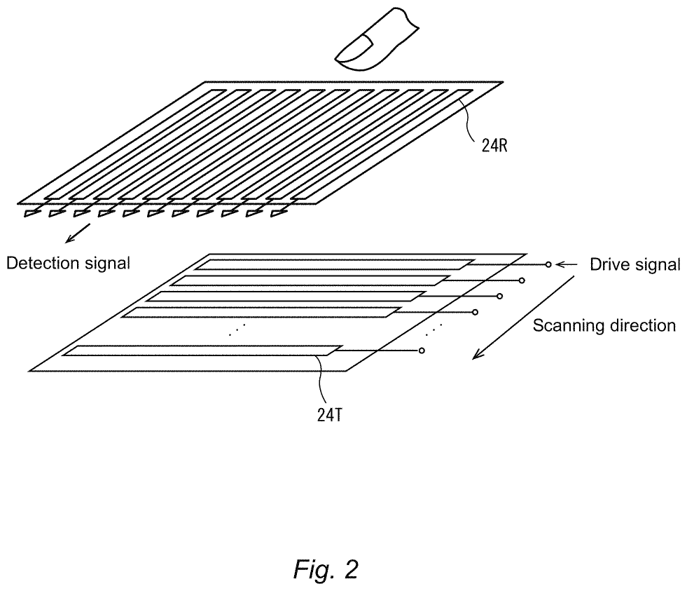

FIG. 2 is a pattern diagram depicting relation between the drive electrodes 24T and the sensing electrodes 24R. As depicted in FIG. 2, the drive electrodes 24T and the sensing electrodes 24R are disposed to be perpendicular to each other, and a touch panel controller (not depicted) scan-drives the drive electrodes 24T one by one while receiving detection signals from the sensing electrodes 24R. If a user touches any portion with a finger or a pen, a detection signal read out of one of the sensing electrodes 24R disposed correspondingly to the touched portion has change in signal value. The touch panel controller checks the change in signal value of the received detection signal to find a touched position on the touch surface.

The drive electrodes 24T have a transparent conductive pattern (transparent electrodes) made of a transparent metal such as ITO. The drive electrodes 24T formed in this manner securely avoid blocking light. The drive electrodes 24T may alternatively have a predetermined pattern formed by cutting away metal mesh of fine wire made of a metal (such as copper). The drive electrodes 24T provided as the metal mesh secure excellent conductivity as well as certain light transmissivity.

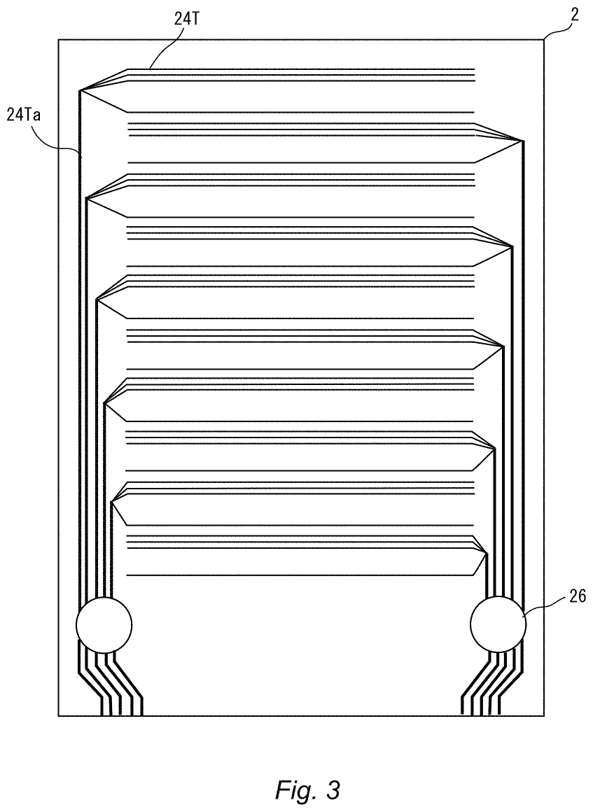

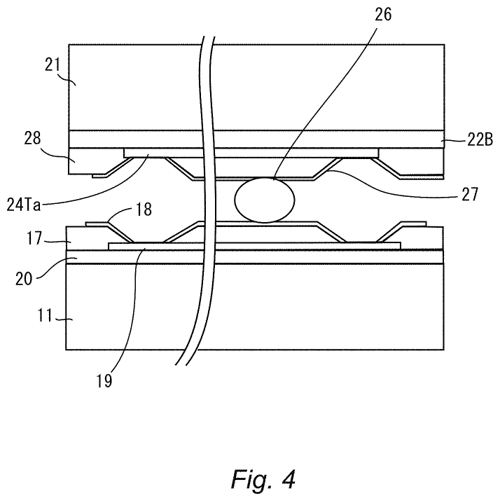

The drive electrodes 24T are connectable to a terminal part of the TFT substrate 1 by means of common transition provided at a sealed portion between the TFT substrate 1 and the color filter substrate 2. FIGS. 3 and 4 are views each depicting an exemplary configuration for connection between the drive electrodes 24T and the terminal part of the TFT substrate 1.

As depicted in FIG. 3, the color filter substrate 2 is provided, on the surface adjacent to the liquid crystal layer 3, with the drive electrodes 24T forming a stripe shape, and the drive electrodes 24T each have a lead line 24Ta led out of the corresponding drive electrode 24T toward a side of the color filter substrate 2. FIG. 3 depicts only part of the lead lines for simplification. The lead lines 24Ta gather in a frame region provided with a common transition electrode 26. The common transition electrode 26 is exemplarily made of a photosetting resin containing conductive particles and nonconductive inorganic filler.

As depicted in FIG. 4, the common transition electrode 26 electrically connects the lead line 24Ta provided on the color filter substrate 2 and a source metal 19 provided on a first interlayer insulating film 20 on the glass substrate 11 of the TFT substrate 1. The lead line 24Ta and the common transition electrode 26 are connected via contact electrode ITO (adjacent to the color filters) 27. The lead line 24Ta and the contact electrode ITO (adjacent to the color filters) 27 are connected via a contact hole provided in an interlayer insulating film 28. The source metal 19 and the common transition electrode 26 are connected via contact electrode ITO (adjacent to the TFT) 18. The source metal 19 and the contact electrode ITO (adjacent to the TFT) 18 are connected via a contact hole provided in a second interlayer insulating film 17. The common transition electrode 26 provided in this manner allows the lead lines 24Ta from the drive electrodes 24T provided on the color filter substrate 2 to be connected to the touch panel controller and the like via the source metal 19 and the terminal part of the TFT substrate 1.

As to be described in detail below, the sensing electrodes 24R are provided in a layer including the antenna pattern 25. The sensing electrodes 24R and the antenna pattern 25 are accordingly preferred to have a predetermined pattern formed by cutting away metal mesh of fine wire made of a metal (such as copper). The sensing electrodes 24R and the antenna pattern 24 provided with use of the metal mesh also secure excellent conductivity as well as certain light transmissivity.

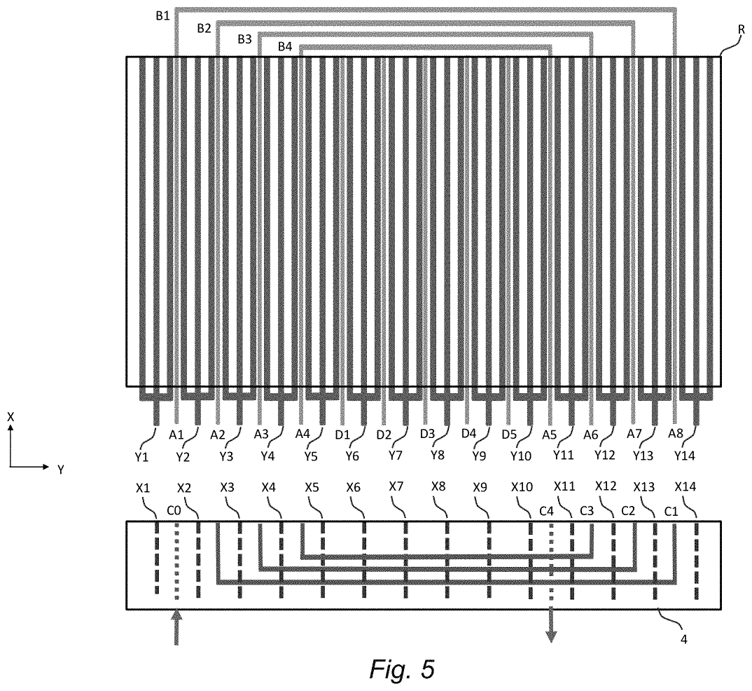

The sensing electrodes 24R and the antenna pattern 25 will be described below in terms of configurations thereof with reference to FIG. 5. As described earlier, the sensing electrodes 24R and the antenna pattern 25 are disposed in the identical layer adjacent to the touch surface of the color filter substrate 2. FIG. 5 is a plan pattern diagram depicting disposition of the sensing electrodes 24R and the antenna pattern 25. FIG. 5 depicts a region denoted by reference sign R and serving as an image display region. In other words, the region outside the region R corresponds to the so-called frame region.

FIG. 5 exemplarily depicts a plurality of electrodes Y1 to Y14 as the sensing electrodes 24R. The number of the electrodes included in the sensing electrodes 24R is not limited to that specifically exemplified in FIG. 5 but may be set appropriately. The electrodes Y1 to Y14 each include three parallel electrode lines extending in an X direction indicated in FIG. 5. These three electrode lines are connected to one another outside the image display region R (in the frame region). The electrode lines of the electrodes Y1 to Y14 are disposed in the image display region R at equal intervals in a Y direction. If the electrode lines are disposed at irregular intervals, the electrode lines are likely to be visually recognized within the image display region R.

FIG. 5 exemplifies antenna lines A1 to A8 configuring the antenna pattern 25 and disposed in the image display region R. The antenna lines A1 to A8 are disposed in a layer including the electrodes Y1 to Y14 functioning as the sensing electrodes 24R. The antenna line A1 is disposed between the electrodes Y1 and Y2. The antenna line A2 is disposed between the electrodes Y2 and Y3. The antenna line A3 is disposed between the electrodes Y3 and Y4. The antenna line A4 is disposed between the electrodes Y4 and Y5. The antenna line A5 is disposed between the electrodes Y10 and Y11. The antenna line A6 is disposed between the electrodes Y11 and Y12. The antenna line A7 is disposed between the electrodes Y12 and Y13. The antenna line A8 is disposed between the electrodes Y13 and Y14.

The antenna lines A1 and A8 are connected to each other in the frame region via an antenna connection line B1 extending mainly in the Y direction. The frame region further includes antenna connection lines B2 and B4 similarly connecting the antenna lines A2 and A7, the antenna lines A3 and A6, and the antenna lines A4 and A5, respectively. The antenna connection lines B1 to B4 may be disposed in a layer including the antenna lines A1 to A8 or may be disposed in a layer different from the layer including the antenna lines A1 to A8.

The frame region includes a first portion provided with the connection lines B1 to B4, and a second portion opposite to the first portion in the X direction and provided with a flexible printed circuits (FPC) board 4. The FPC board 4 is provided thereon with sensor electrode relay lines X1 to X14. The sensor electrode relay lines X1 to X14 are provided for transmission of signals read out of the electrodes Y1 to Y14 functioning as the sensing electrodes 24R to the touch panel controller.

The FPC board 4 is further provided thereon with antenna connection lines C0 to C4. The antenna connection line C1 connects the antenna lines A2 and A8. The antenna connection line C2 connects the antenna lines A3 and A7. The antenna connection line C3 connects the antenna lines A4 and A6. The antenna connection line C0 connects the antenna line A1 and an antenna controller (not depicted). The antenna connection line C0 connects the antenna line A1 and the antenna controller.

Contact between lines on the FPC board 4 can be avoided by causing one of the lines to bypass a portion where any one of the sensor electrode relay lines X3 to X13 and any one of the antenna connection lines C1 to C3 cross each other in a planar view, by being provided on a rear surface of the FPC board 4 via a contact hole, for example.

As described above, FIG. 5 exemplifies a case where the antenna lines A1 to A8, the antenna connection lines B1 to B4, and the antenna connection lines C0 to C4 configure a winding loop antenna. FIG. 5 exemplarily depicts the antenna having four spirals, although the number of spirals can be determined appropriately.

As depicted in FIG. 5, the electrodes Y5 and Y6, the electrodes Y6 and Y7, the electrodes Y7 and Y8, and the electrodes Y8 and Y9 interpose dummy lines D1 to D4, respectively. The dummy lines D1 to D4 are provided in order to prevent visual adverse influence of gaps provided with no antenna line between adjacent ones of the electrodes Y1 to Y14. The dummy lines D1 to D4 are disposed in a layer including the electrodes Y1 to Y14 and the antenna lines A1 to A8. Each of the dummy lines D1 to D4 is made of a material same as a material for the antenna lines A1 to A8 and is formed to be equal in width to the antenna lines A1 to A8. The electrodes Y1 to Y14 may each include dummy lines disposed between adjacent ones of the three electrode lines.

The touch panel display 100 according to the present embodiment includes a single or a plurality of loop antennas depicted in FIG. 5. The antenna controller applies a drive signal to each of the loop antennas. The antenna controller drives the loop antennas at sine waves having 13.56 megahertz in order to detect a near field communication (NFC) card. The loop antennas can thus detect whether or not there is an NFC card. In the configuration including the plurality of loop antennas, specifying one of the loop antennas having detected the card leads to specifying a position of the detected card.

According to the embodiment described above, the sensing electrodes configured to detect a touch are provided in the layer including the antenna pattern to achieve reduction in thickness of the device, in comparison to a conventional configuration including electrodes for a touch panel and an antenna pattern disposed in layers different from each other. The antenna pattern disposed in the layer including the sensing electrodes reduces influence of antenna noise in comparison to a case where the sensing electrodes and the antenna pattern are layered.

The sensing electrodes configured to detect a touch, the drive electrodes, and the antenna pattern are provided on the color filter substrate, to reduce influence of noise caused by drive for image display, on detection of a touch and detection of an NFC card or the like by means of the antenna pattern. It is because the configuration according to the present embodiment includes the driver element and the lines for image display disposed on the TFT substrate. This enables detection of a touch without limitation by image display operation timing. This effect is particularly advantageous for a high-resolution display having a large number of pixels or a large-screen display.

Influence of drive of the TFT in the display on operation of the touch panel and the antenna may be prevented by driving the drive electrodes of the touch panel and driving the antenna pattern while the TFT in the display is halted.

The embodiment described above is merely exemplified for implementation of the present invention. The present invention should not be limited to the embodiment described above, and can be implemented with appropriate modifications to the above embodiment without departing from the spirit of the present invention.

The above embodiment exemplifies the configuration including the color filter substrate provided with the drive electrodes disposed adjacent to the liquid crystal layer, and the sensing electrodes and the antenna pattern disposed adjacent to the touch surface. In contrast, the present invention is also applicable to a configuration including the color filter substrate provided with the sensing electrodes disposed adjacent to the liquid crystal layer, and the drive electrodes and the antenna pattern disposed adjacent to the touch surface. The configuration including the sensing electrodes disposed adjacent to the touch surface of the color filter substrate is advantageous in that liquid crystal drive noise does not affect touch detection signals read out of the sensing electrodes.

The antenna pattern is preferably provided not adjacent to the liquid crystal layer but adjacent to the touch surface of the color filter substrate, in terms of secured communication sensitivity.

The above description exemplifies an IC card and an NFC card as an information reading target by means of near field wireless communication. The reading target is not limited to cards, but the present invention can adopt targets according to various aspects.

### REFERENCE SIGN LIST

100 touch panel display including antenna
1 TFT substrate
2 color filter substrate
3 liquid crystal layer
11 glass substrate
12 gate line
13 insulating film
14 transparent auxiliary electrode
15 insulating film
16 pixel electrode
17 second interlayer insulating film
18 contact electrode ITO (adjacent to TFT)
20 first interlayer insulating film
21 glass substrate
22 color filter layer
23 oriented film
24T drive electrode
24Ta lead line
24R sensing electrode
26 common transition electrode
27 contact electrode ITO (adjacent to color filters)
28 interlayer insulating film

1: A touch panel display including an antenna configured to read information using near field wireless communication, the touch panel display comprising:
a first substrate and a second substrate;
a display medium interposed between the first substrate and the second substrate; and
a first touch sensor electrode provided on a display medium side of the first substrate; wherein
the first substrate includes a second touch sensor electrode and the antenna that are disposed in an identical layer on a surface of the first substrate opposite to the display medium.

2: The touch panel display including the antenna according to claim 1, wherein
the display medium is liquid crystal,
the second substrate is a circuit board provided with a driver element, and
the first substrate is a color filter substrate.

3: The touch panel display including the antenna according to claim 2, wherein
the first touch sensor electrode is a drive electrode, and
the second touch sensor electrode is a sensing electrode.

4: The touch panel display including the antenna according to claim 1, wherein the second touch sensor electrode and the antenna are disposed in parallel with each other in an image display region of the touch panel display on the surface of the first substrate opposite to the display medium.

5: The touch panel display including the antenna according to claim 4, wherein
the antenna has a loop shape or a spiral shape having two or more spirals, and
the antenna has a portion that is not in parallel with the second touch sensor electrode, the portion being disposed outside the image display region.

6: The touch panel display including the antenna according to claim 4, the touch panel display further comprising
a flexible circuit board, wherein
the antenna has a portion that is not in parallel with the second touch sensor electrode, the portion being at least partially disposed on the flexible circuit board.
